(19) United States
(12) Patent Application Publication
(10) Pub. No.: US 2009/0269117 A1
(43) Pub. Date: Oct. 29, 2009

(54) PAGE IDING FOR POST PROCESSING PRINTING

(76) Inventors: Brian P. Wilson, Marion, NY (US); Alan Randt, Fairport, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(21) Appl. No.: 12/110,518

(22) Filed: Apr. 28, 2008

(51) Int. Cl. B41J 5/30

(52) U.S. Cl. 400/73

(57) ABSTRACT

A system and method for implementing identification tags for print projects is disclosed. The method includes programming variable unique identification tags in each image of a job and subset of the job and printing the job on a form of media with the identification tag where the identification tag contains information capable of linking the form of media to the job. The identification tag may be implemented to microprinting, visual encoding, or infrared watermarking. The identification tag enables re-feeding the job for an update without the job needing to be fed in any certain type of order. Furthermore, even if the wrong job is fed into a printer/finisher, the update will not be implemented unless it is specifically programmed into the printer/finisher.

### BACKGROUND

The following relates to the printing and marking arts. It finds particular application in conjunction with page identification for post-process printing and thus will be described with particular reference thereto. However, it should be appreciated that some embodiments are amenable to other applications including but not limited to multiple printing systems and other finishing devices.

By way of background, conventional process printing includes programming a job into a printer in a terminal state. Generally speaking, after a job has been printed, if the operator would like to make an update, the operator has two choices. The operator may either begin the printing job over or reprogram the printing system in order that it may correct or update the appropriate pages. If the operator chooses to perform the latter, the operator must re-feed the page or pages to be updated in the appropriate order. This is mainly because the printing system has no way to identify each individual page in a job.

In view of the above, there is an unresolved need in the industry to deliver jobs that may be identified by a printer system after processing. Furthermore, there is a need for this identification to be hidden as to not interfere with the aesthetics of the print job. There is also a need for the pages themselves to be linked to the job and subset of the job in which they belong. Moreover, there is an unresolved need for the system and method to meet these challenges without adding significant costs to the printing system.

### CROSS REFERENCE TO RELATED PATENTS AND APPLICATIONS

The following applications, the disclosures of each being totally incorporated herein by reference as mentioned:

U.S. application Ser. No. 10/999,326 (Attorney Docket 20040314-US-NP), filed Nov. 30, 2004, entitled “SEMI-AUTOMATIC IMAGE QUALITY ADJUSTMENT FOR MULTIPLE MARKING ENGINE SYSTEMS,” BY Robert E. Grace, et al.;

U.S. application Ser. No. 11/090,502 (Attorney Docket 2031468-US-NP), filed Mar. 25, 2005, entitled “IMAGE QUALITY CONTROL METHOD AND APPARATUS FOR MULTIPLE MARKING ENGINE SYSTEMS,” by Michael C. Mongeon;

U.S. application Ser. No. 11/115,766 (Attorney Docket 20040656-US-NP, Filed Apr. 27, 2005, entitled “IMAGE QUALITY ADJUSTMENT METHOD AND SYSTEM,” by Robert E. Grace;

U.S. application Ser. No. 11/274,638 (Attorney Docket 20050689-US-NP), filed Nov. 15, 2005, entitled “GAMUT SELECTION IN MULTI-ENGINE PRINTER CALIBRATION USING COMPROMISE AIM,” by Wencheng Wu, et al.

### BRIEF DESCRIPTION

Aspects of the present disclosure and embodiments thereof include apparatus and method embodiments. One embodiment includes a method for implementing identification tags for print projects comprising programming variable unique identification tags in each image of a job and a subset of the job and printing the job on a form of media with the identification tag where the identification tag contains information capable of linking the form of media to the job.

According to another aspect of the claimed disclosure, the method includes that the identification tag is implemented through microprinting, infrared watermarking, and/or ultraviolet encoding.

According to another aspect of the claimed disclosure, the method includes linking printed media to a job for post-processing activities comprising generating a unique identification tag that corresponds to a job and processing the job onto a substrate where the media includes the unique identification tag embedded within.

According to another aspect of the claimed disclosure, a printing system includes a printer configured to print identification tags on printer media where the identification tags are unique, visually undetectable and contain information relating to a corresponding job and job subset, and an identification tag reader configured to read the identification tags and process the information contained therein.

### BRIEF DESCRIPTION OF THE DRAWINGS

FIG. 1 is an illustration that schematically depicts a printing system and the resultant substrate having an identification mark;

FIG. 2 provides a flowchart of the method for implementing identification tags for a print project according to one embodiment of the present disclosure; and

FIG. 3 provides a flowchart illustration of one of the methods according to the present disclosure.

### DETAILED DESCRIPTION

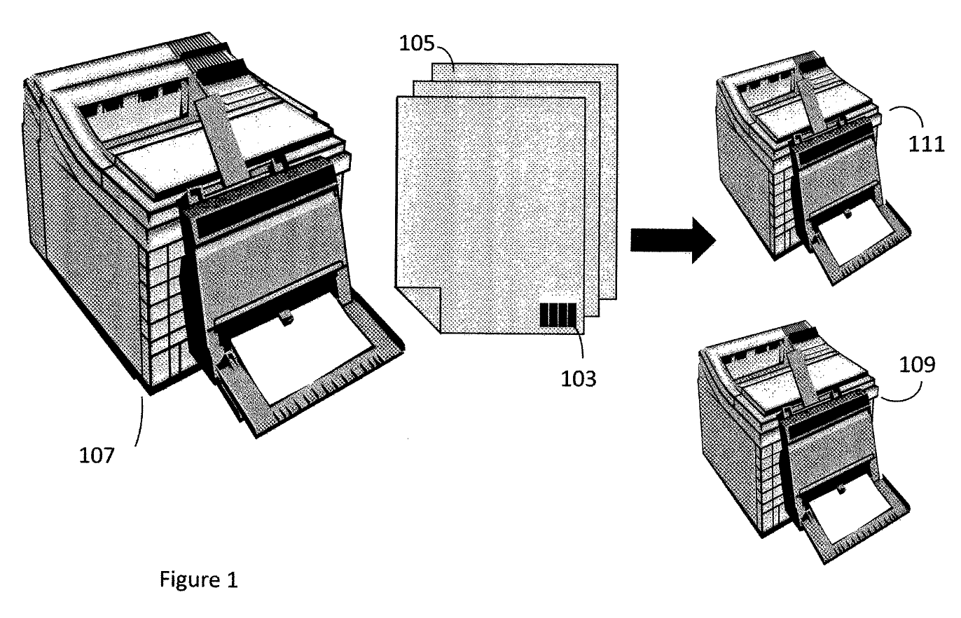

With reference to FIG. 1, a portion of a printing system infrastructure is illustrated. The printing system infrastructure includes a first printer 107 configured to print an identification tag 103 on a substrate 105. The system also includes a second printer/finisher device 109 and a third printer/finisher device 111. The first printer 107, the second printer/finisher device 109, and third printer/finisher device 111 may include a variety of different devices such as a digital front end, one or more roster image processors, etc. Each of these printers 107, 109, 111 may be used to convert data to a suitable format that can be processed by the system. For example, the first printer 107 may be able to convert a post subscript file to a CMYK file and print the resulting image onto a substrate 105. The second printer/finisher 109 may be used for stapling, sorting, or any variety of finishing processes. The third printer/finisher 111 may be configured to do any of the above. The second printer/finisher device 109 and third printer/finisher device 111 may be in communication in order to dictate Tightly Integrated Parallel Processing (TIPP). The printing infrastructure displayed in FIG. 1 may include a variety of systems and should not be limited to the configuration shown. This is but one example of a system which may be used to implement the claimed process. A variety of other infrastructures may be implemented and still fall within the spirit of the claims.

Still referring to FIG. 1, a printing infrastructure is provided. The first printer 107 is configured to print identification tags 103 onto printer media 105. The identification tag 103 is unique and generally visually undetectable. The identification tag 103 also contains information related to a corresponding job and/or job subset. The identification tag 103 may be implemented through microprinting. In this form, the identification tag 103 will be printed onto the printer media 105 in print too small to be read by the naked human eye. However, this print may be detectable through other means described in further detail below. Another method of implementing the identification tag 103 onto the printer media 105 is through ultraviolet encoding. In this form, the identification tag 103 may be printed with ink having ultraviolet absorption characteristics. In this embodiment, the identification tag may be substantially larger and/or printed throughout the image. However, similar to microprinting, generally this identification tag 103 is visually undetectable. In another form, the identification tag 103 may be implemented through infrared watermarking. Again, the printing ink may include infrared absorption qualities which facilitate detection through infrared reading devices. However, generally, the watermark would not be seen through visual inspection.

The identification tag 103 is printed on a type of printer media 105 in the form of a substrate. In yet another embodiment, the substrate is printer paper. In yet another embodiment, the substrate is the pages of a book. Each page or section of substrate may be classified as a subset whereas the work as whole may be classified as a job. In any form, the identification tag 103 may be placed on each job or each subset of the job. In one embodiment, the identification tag 103 is placed on each job subset so that when the entire job is placed into a finishing device 109, 111 where the job may be sorted. In this form, the order of the pages in the job may be established through the identification tag 103.

The system also includes a first and second printer/finisher 109, 111. These two devices may be in communication with one another in order to facilitate TIPP printing. In any form, the first and second printer/finisher 109, 111 may include an identification tag reader which reads the identification tag 103 printed on the printer media 105. When the substrate requires the services of the first and/or second printer/finisher 109, 111, the entire job or a subset of the job may be re-fed into the appropriate printer/finisher 109, 111 and the job may be finished and/or updated as appropriate. The printer/finisher 109, 111 is configured to read the identification tag 103 on the substrate in order to identify which page the printer/finisher 109, 111 has been fed. If the printer/finisher 109, 111 is programmed to update a single page, that page can be searched for and updated when or if it is found.

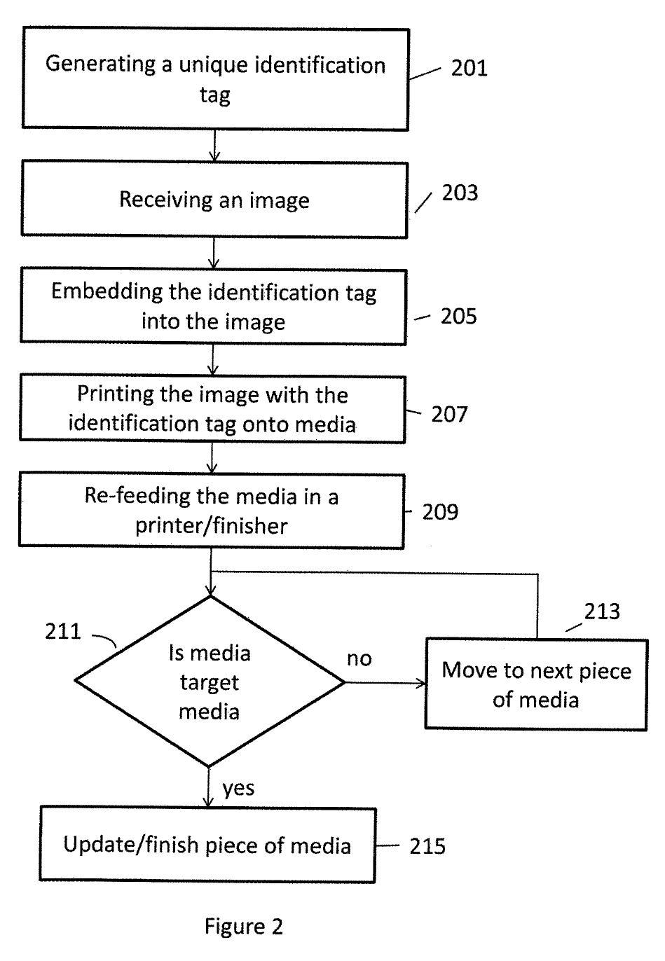

Now referring to FIG. 2, a method of implementing identification tags for a printing project is shown. The method begins with the generating a unique identification tag (at step 201). The unique identification tag 103 FIG. 2 may be a machine readable mark. The identification tag 103 is used in order to link a job or a subset of a job to the physical substrate that it was printed upon. The unique identification tag 103 may be a bar code or any other machine readable mark.

The method continues (at step 203) with receiving an image. The job that has been programmed into the printer 107 generally includes images. The printer 107 is configured to receive the desired image from some type of user interface.

The method continues with embedding an identification tag into the image (at step 205). The identification tag 103 may be embedded into the image in a way where a user will not be able to notice. These methods may include microprinting, ultraviolet encoding, infrared marking, etc.

The method continues with printing the image including the identification tag onto media (at step 207). Once the image has embedded within an identification tag 103, the identification tag reader will be able to identify the job and/or sub-job into which each individual piece of media 105 belongs. In this form, the printing job is not in the terminal state. The printing job instead may be updated whenever the user chooses to update it.

The method continues with re-feeding the media into a printer/finisher (at step 209). An identification tag reader will be able to identify the page of the job that was re-fed into the printer/finisher, as well as the job itself.

The method continues with determining if the media is the target piece of media. In this form, the ID reader will be able to link the piece of media to a specific programmed job or subset of a job, once a target piece of media is identified. If the media that was fed into the job matches the piece of media that is targeted, the printer/finisher will be able to act accordingly. If the piece of media before the printer/finisher is not the target piece of media, the printer/finisher will move on to the next piece of media (at step 213). However, if the piece of media that is encountered by the target printer/finisher is the target piece of media, then the printer/finisher will be able to update and/or finish the piece of media (at step 215). It should be noted that this method may incorporate re-feeding the job or subset of the job into the same printer that originally printed the image.

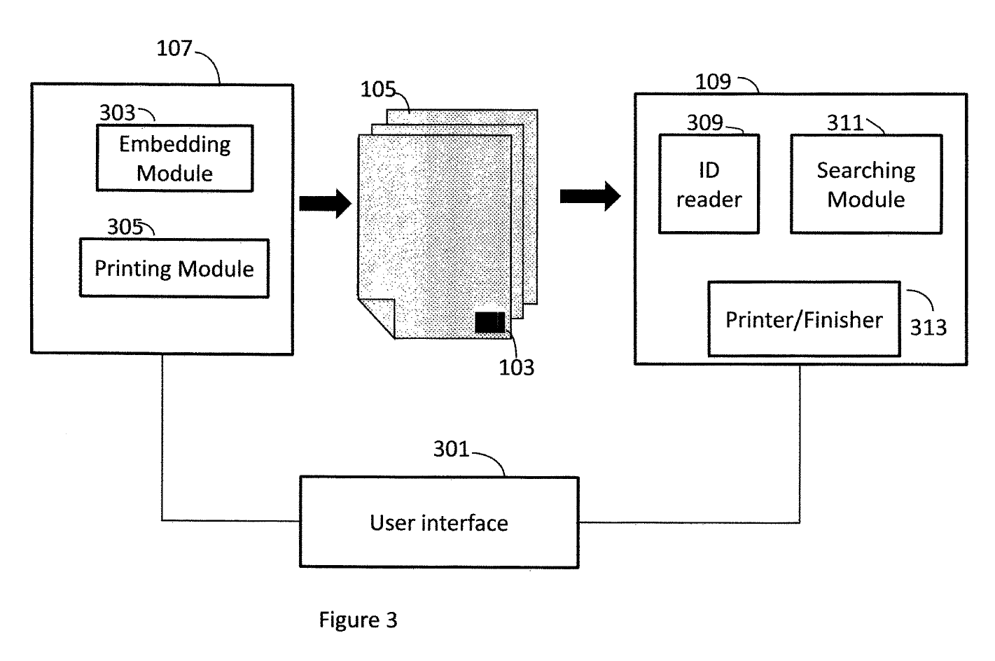

Now referring to FIG. 3, a schematic representation of the system into which the claimed method may be incorporated is shown. The system includes a user interface 301, an embedding module 303, a printing module 305, and identification tag reader 309, a searching module 311, and a printer/finisher 313. It should be noted that this is only one of a variety of possible schematics which may be used to represent the system into which the claims may be incorporated.

The user interface 301 is in communication with the first printer 107 and the printer/finisher device 109. The user interface is configured to accept user input. The user input may include updating and/or finishing directions. In this form, a user may program a job through the first printer 107.

Under this scenario, the first printer 107 may receive the image and embed an identification tag 103 into the image. The printing module 305 is then configured to print the image onto a substrate 105 including the identification tag 103. In some embodiments the identification tag may be printed via microprinting and/or through use of a watermark.

Although the job has been printed onto a substrate 105, it need not be the case that this job is in the terminal state. For example, if there was a mistake in the printing or the printer malfunctioned and needed to print an update, the user may reprogram the job via the user interface 301.

The user may re-feed the job into the printer/finisher 109. Through this disclosure the pages need not be re-fed in any particular order. The pages 105 may even be the wrong job. Through this disclosure the identification tag reader 309 will read the identification tag 103 and determine whether or not that piece of media is the correct media to update. In this respect, if the user feeds the wrong job through the printer/finisher 109 no update will be implemented because none of the individual pieces of media will be the target piece of media.

In order to identify the target piece of media, the searching module 311 is implemented. Once the searching module 311 identifies that the correct target media has been found, the printer/finisher module 313 will finish the job as programmed via the user interface 301.

The above description merely provides a disclosure of the particular embodiments and is not intended for purposes of limiting the same thereto. As such, this disclosure is not limited only to the above described embodiments, rather it is recognized that one skilled in the art could conceive alternative embodiments that fall within the scope of the claims.

It will be appreciated that variations of the above-disclosed and other features and functions, or alternatives thereof, may be desirably combined into many other different systems and/or applications. Also that various presently unforeseen or unanticipated alternatives, modifications, variations or improvements therein may be subsequently made by those skilled in the art which are also intended to be encompassed by the following claims.

1. A method for implementing identification tags for print project comprising:
programming variable, unique identification tags in each image of a job and a subset of said job; and
printing said job on a form of media with said identification tag, where each said identification tag contains information capable of linking said form of media to said job.

2. The method according to claim 1 wherein said identification tag is implemented through microprinting.

3. The method according to claim 1 wherein said identification tag is implemented through ultraviolet encoding.

4. The method according to claim 1 wherein said identification tag is implemented through infrared watermarking.

5. The method according to claim 1 wherein said job is printed by a multiple printer system.

6. The method according to claim 1 wherein said identification tags is visually undetectable.

7. The method according to claim 1, further comprising:
re-feeding said job for an update to said job or said subset via identification tag;
searching for said identification tag; and
updating said job.

8. The method according to claim 1, further comprising processing said job for a finishing device that is configured read said identification tag.

9. The method according to claim 1 wherein said job is printed by a tightly integrated parallel printing system.

10. A method for linking printed media to a job for post process activities comprising:
generating a unique identification tag that corresponds to a job; and
processing said job onto a substrate where said media includes said unique identification tag embedded within.

11. The method according to claim 10 wherein said substrate is a transparency.

12. The method according to claim 10 wherein said substrate is paper.

13. The method according to claim 10, further comprising after processing, feeding said substrate into a device configured to read said unique identification tags and to target at least one unique identification tag for further processing of said corresponding substrate.

14. The method according to claim 13 wherein said further processing includes erasing at least part of the content on said substrate.

15. The method according to claim 13 wherein said further processing includes overwriting at least part of the content on said substrate.

16. The method according to claim 13 wherein said device is a finishing device.

17. A xerographic printing system comprising:
a printer configured to identification tags on printer media, where said identification tags are unique, visually undetectable, and contain information relating to a corresponding job and job subset; and
a reader configured to read said identification tags and process said information contained therein.

18. The system according to claim 17, further comprising a human interface.

19. The system according to claim 17, further comprising a finisher that is in communication with said reader, in order that said finisher is configured to process said job at least in part by accessing said identification tag information.

20. The system according to claim 17 wherein said printer is part of a tightly integrated parallel processing system.
